(19) United States
(12) Patent Application Publication
(10) Pub. No.: US 2013/0201250 A1
(43) Pub. Date: Aug. 8, 2013

(54) POLYURETHANE DISPERSANTS BASED ON ASYMMETRIC BRANCHED TRISUBSTITUTED ISOCYANATE REACTIVE COMPOUNDS.

(71) Applicant: Charles T Berge, Earleville, MD (US)

(72) Inventor: Charles T Berge, Earleville, MD (US)

(73) Assignee: E I Du Pont De Nemours And Company, Wilmington, DE (US)

(21) Appl. No.: 13/878,240

(22) PCT Filed: Oct. 20, 2011
(86) PCT No.: PCT/US11/57082

§ 371 Date: Apr. 8, 2013

Related U.S. Application Data
(60) Provisional application No. 61/408,033, filed on Oct. 29, 2010.

(51) Int. Cl. C09D 11/00

(52) U.S. Cl. CPC C09D 11/30
USPC 347/20; 524/591; 528/85

(57) ABSTRACT

Polyurethane dispersants are provided based on asymmetric branched trisubstituted isocyanate reactive compounds. These polyurethane dispersants are used to disperse pigments and/or disperse dyes and inks containing pigments and/or disperse dyes dispersed with these polyurethane ionic dispersants. The polyurethane dispersants can have nonionic hydrophilic substituents. The pigments dispersed with these polyurethane dispersants can be used in the formulation of inks, especially ink jet inks.

### CROSS-REFERENCE TO RELATED APPLICATION

This application claims priority under 35 U.S.C. §119 from U.S. Provisional Application Ser. No. 61/408,033, filed Oct. 29, 2010.

### FIELD OF THE INVENTION

Polyurethane dispersants are provided based on asymmetric branched trisubstituted isocyanate reactive compounds. These polyurethanes dispersants are effective for dispersion of particles, especially pigments. Pigments dispersed with the polyurethane dispersants can be used in ink jet inks.

### BACKGROUND OF THE INVENTION

Disclosed herein are polyurethane dispersants which can be used to make novel, stable aqueous particle dispersions. The polyurethane dispersants are especially useful for aqueous pigment dispersions. Also described is the process for making the pigment dispersions and the use thereof in ink jet inks.

Polyurethanes can be used as ink additives for ink jet inks and as such are added at the ink formulation stage. But they can also be used as dispersants for pigments.

Polyurethane dispersions that are used as pigment dispersants have been described in U.S. Pat. No. 6,133,890. These polyurethanes are prepared with an excess of isocyanate reactive group and are limited to the presence of polyalkylene oxide components. WO2009/076381 describes polyurethane dispersants based on diols and polyether diols but the polyurethanes do not have asymmetric branched trisubstituted isocyanate reactive compounds. Aqueous polyurethane dispersants have found limited use as dispersants for pigments and the like.

Therefore, there is still a need for a new class of polyurethane dispersants that can stably disperse particles, especially pigment particles in aqueous medium. The pigment particles dispersed with polyurethane dispersants are especially suited for use in aqueous inkjet inks.

### SUMMARY OF THE INVENTION

An embodiment provides a new class of polyurethane dispersants which are derived from asymmetric branched trisubstituted isocyanate reactive compounds that produce stable aqueous dispersions of pigments. These pigment dispersions can be utilized for ink jet inks.

A further embodiment provides an aqueous pigment dispersion comprising an aqueous vehicle, a pigment and a polyurethane dispersant, wherein
(a) the polyurethane dispersant physically adsorbs to the pigment,
(b) the polyurethane dispersant stably disperses the pigment in the aqueous vehicle,
(c) the asymmetric branched polyurethane dispersant comprising a trisubstituted branching compound, a first diol, a second diol substituted with an ionic group, and isocyanates

where the trisubstituted branching compound has three isocyanate reactive substituents where the first isocyanate reactive substituent is a primary or secondary amine, and the second and third isocyanate reactive substituents are the same or different and are selected from the group consisting of a primary or secondary amine, OH, and SH and where at least one of the second and third isocyanate reactive substituents are OH or SH,

wherein the isocyanate reactive substituents of the trisubstituted branching compound is from 0.4 to 30 mole percent of the total isocyanate reactive substituents including the trisubstituted branching compound and

wherein the average pigment size of the aqueous pigment dispersion is more than about 25 nm and less than about 300 nm.

A further embodiment provides an aqueous colored ink jet ink comprising the aqueous pigment dispersion having from about 0.1 to about 10 wt % pigment based on the total weight of the ink, a weight ratio of the pigment to the polyurethane dispersant of from about 0.5 to about 6, a surface tension in the range of about 20 dyne/cm to about 70 dyne/cm at 25° C., and a viscosity of lower than about 30 cP at 25° C.

Another embodiment provides the ink sets in comprising at least three differently colored inks (such as CMY), and optionally at least four differently colored inks (such as CMYK), wherein at least one of the inks is an aqueous inkjet ink comprising the pigment dispersed with the polyurethane dispersant described above.

When a black ink is included in the CMYK ink set the black ink can be a self-dispersed black pigment.

The other inks of the ink set are preferably also aqueous inks, and may contain dyes, pigments or combinations thereof as the pigment. Such other inks are, in a general sense, well known to those of ordinary skill in the art.

In another aspect, the disclosure provides a method of ink jet printing onto a substrate comprising, in any workable order, the steps of:

(a) providing an ink jet printer that is responsive to digital data signals;

(b) loading the printer with a substrate to be printed;

(c) loading the printer with an aqueous ink jet ink comprising an aqueous ink vehicle, a pigment dispersed with the polyurethane dispersant described above;

(d) printing onto the substrate using the aqueous ink jet ink, in response to the digital data signals to form a printed image on the substrate.

In yet another aspect, the disclosure provides a method of ink jet printing onto a substrate comprising, in any workable order, the steps of:

(a) providing an ink jet printer that is responsive to digital data signals;

(b) loading the printer with a substrate to be printed;

(c) loading the printer with an aqueous inkjet ink set where at least one of the inks in the ink set comprises an aqueous ink vehicle, a pigment dispersed with the polyurethane dispersant described above;

(d) printing onto the substrate using the aqueous ink jet ink, in response to the digital data signals to form a printed image on the substrate.

These and other features and advantages of the present invention will be more readily understood by those of ordinary skill in the art from a reading of the following Detailed Description.

Certain features of the invention which are, for clarity, described above and below as separate embodiments, may also be provided in combination in a single embodiment.

Conversely, various features of the invention that are described in the context of a single embodiment may also be provided separately or in any subcombination.

### DETAILED DESCRIPTION

Unless otherwise stated or defined, all technical and scientific terms used herein have commonly understood meanings by one of ordinary skill in the art to which this invention pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, reference to enhanced or improved “print quality” means some aspect of optical density of the printed images and fastness (resistance to ink removal from the printed image) is increased, including, for example, rub fastness (finger rub), water fastness (water drop) and smear fastness (highlighter pen stroke).

As used herein, the term “binder” means a film forming ingredient in an inkjet ink.

As used herein, the term “self-dispersed pigment” means a “self-dispersible” or “self-dispersing” pigments.

As used herein, the term “dispersion” means a two phase system where one phase consists of finely divided particles (often in the colloidal size range) distributed throughout a bulk substance, the particles being the dispersed or internal phase and the bulk substance the continuous or external phase.

As used herein, the term “dispersant” means a surface active agent added to a suspending medium to promote uniform and maximum separation of extremely fine solid particles often of colloidal size. For pigments the dispersants are most often polymeric dispersants and usually the dispersants and pigments are combined using dispersing equipment.

As used herein, the term “nonionic” means a substructure of a compound which has repeating —CH₂CH(R)O— groups that impart nonionic character to the compound; these groups can be incorporated into polymeric dispersants.

As used herein, the term “OD” means optical density.

As used herein, the term “CMY” means the colorants cyan, magenta and yellow used in inks; K or black can be included in the ink description.

As used herein, the term “aqueous vehicle” refers to water or a mixture of water and at least one water-soluble organic solvent (co-solvent).

As used herein, the term “aromatic” means a cyclic hydrocarbon containing one or more rings typified by benzene which has a 6 carbon ring containing three double bonds. Aromatic includes cyclic hydrocarbons such as naphthalene and similar multiple ring aromatic compounds.

As used herein, the term “alkyl” means a paraffinic hydrocarbon group which may be derived from an alkane and the formula is CₙC₂ₙ₊₁.

As used herein, the term “ionizable groups” means potentially ionic groups.

As used herein, the term “AN” means acid number, mg KOH/gram of solid polymer.

As used herein, the term “neutralizing agents” means to embrace all types of agents that are useful for converting ionizable groups to the more hydrophilic ionic (salt) groups.

As used herein, the term “substantially” means being of considerable degree, almost all.

As used herein, the term “Mn” means number average molecular weight.

As used herein, the term “Mw” means weight average molecular weight.

As used herein, the term “PD” means the polydispersity which is the weight average molecular weight divided by the number average molecular weight.

As used herein, the term “d50” means the particle size at which 50% of the particles are smaller; “d95” means the particle size at which 95% of the particles are smaller.

As used herein, the term “cP” means centipoise, a viscosity unit.

As used herein, the term “prepolymer” means the polymer that is an intermediate in a polymerization process, and can be also be considered a polymer.

As used herein, the term “PUD” means the polyurethanes dispersions described herein.

As used herein, the term “DBTL” means dibutyltin dilaurate.

As used herein, the term “DMPA” means dimethylol propionic acid.

As used herein, the term “EDTA” means ethylenediaminetetraacetic acid.

As used herein, the term “HDI” means 1,6-hexamethylene diisocyanate.

As used herein, the term “GPC” means gel permeation chromatography.

As used herein, the term “IPDI” means isophorone diisocyanate.

As used herein, the term “TMDI” means trimethylhexamethylene diisocyanate.

As used herein, the term “TMXDI” means m-tetramethylene xylylene diisocyanate.

As used herein, the term “NMP” means n-Methyl pyrrolidone.

As used herein, the term “TEA” means triethylamine.

As used herein, the term “THF” means tetrahydrofuran.

As used herein, the term “Tetraglyme” means Tetraethylene glycol dimethyl ether.

TERATHANE 650 is a 650 molecular weight, polytetramethylene ether glycol (PTMEG) commercially available from Invista, Wichita, Kans.

Unless otherwise noted, the above chemicals were obtained from Aldrich (Milwaukee, Wis.) or other similar suppliers of laboratory chemicals.

The materials, methods, and examples herein are illustrative only and, except as explicitly stated, are not intended to be limiting.

The use of polymeric conventional dispersants is well established as a means to make stable dispersions of particles, especially pigment particles. In general, these conventional dispersants have, at least, modest water solubility and this water solubility is used as a guide to predicting dispersion stability. These dispersants are most often based on acrylate/acrylic compounds. During diligent searching for new, improved polymeric dispersants, a new class of dispersants has been found that are based on polyurethanes which are derived from asymmetric branched trisubstituted isocyanate reactive compounds. The ionic content in these dispersants can come from the isocyanate-reactive components that have ionic substitution.

In order for a dispersant to stably disperse a particle, the dispersion must be stable for at least a week when stored at room temperature. When the dispersion is observed after being stored after a week, a stable dispersion would still have less than 5% clear liquid on the top of the dispersion. If there is clear liquid, this indicates that the dispersion has become unstable and may be flocculating. For specific applications, heating the dispersions for a set time can be done to determine relative stability among different dispersions. Another criteria for stability is to measure properties of the dispersion, such as viscosity, particle size, pH, conductivity and the like. Comparing particle size is a good way to determine dispersion stability. For the pigments used in inkjet inks the average particle size should be more than about 25 nm and less than about 300 nm. Upon storage the particle size of the pigment dispersion should not change significantly.

While seeking a balance of new performance parameters needed, polymeric dispersants were sought to enable preparing stabilized pigments. Polyurethane dispersants which have as a key structural feature an asymmetric branch point derived from a trisubstituted branching compound which has three isocyanate reactive substituents where the first isocyanate reactive substituent is a primary or secondary amine, and the second and third isocyanate reactive substituents are the same or different and are selected from the group consisting of a primary or secondary amine, OH, and SH and where at least one of the second and third isocyanate reactive substituents are OH or SH. The amount of the trisubstituted asymmetric branching compound in the polyurethane is from 0.4 to 30 mole percent based on all of the isocyanate reactive components. Alternatively, the amount of trisubstituted branching compound can be from 0.6 to 20 mole percent. The asymmetry of the branching point is an important feature.

While not being bound by theory, it is speculated that the asymmetric branching modifies the polyurethane dispersants sufficiently to produce stable dispersions of pigments. The amount of branching is limited by the amount of the trisubstituted branching compound included in the polyurethane synthesis. If there is too much branching the polyurethane will not improve the ink performance.

The polyurethane dispersants comprise isocyanate compounds and isocyanate reactive compounds. The amount of trisubstituted asymmetric branching compound is described in terms of mole percent of all of the isocyanate reactive compounds. By example, the isocyanate reactive compounds can include the trisubstituted asymmetric branching compound, the first diols, the second diols substituted with an ionic group and any isocyanate reactive compounds used as chain terminators. Thus, in this example the mole percent of the isocyanate reactive groups in the trisubstituted asymmetric branching compound is calculated by dividing the moles of the isocyanate reactive groups of the trisubstituted asymmetric branching compound by the sum of the moles of the isocyanate reactive groups of the trisubstituted branching compound, the first diols, the second diol substituted with an ionic group and the chain terminating compound. The amount is reported as a mole percent.

During the synthesis of the polyurethane dispersants the sequence of the reacting components is not critical to obtaining the branched polyurethane. The trisubstituted asymmetric branching compound can be added with the other diols prior to the addition of the diisocyanates. Although not being bound by theory, the reactivity of the amines (as primary and secondary) is sufficiently higher than the —OH and the —SH groups that the branching likely occurs early in the reaction process. During the synthesis it is not necessary to add the trisubstituted branching compound to the diisocyanate prior to addition of the other diols. The addition of the branching compound, the first diol and the second diol can be done in any convenient order.

### Colorants

Suitable colorants are pigments. Other colorants may be used in combination with polyurethane ionic dispersed pigments.

Pigments suitable for use are those generally well-known in the art for aqueous inkjet inks. Representative commercial dry pigments are listed in U.S. Pat. No. 5,085,698. Dispersed dyes are also considered pigments as they are insoluble in the aqueous inks used herein.

Pigments which have been stabilized by the polyurethane dispersant described above may also have these dispersants crosslinked after the pigments are dispersed. An example of this crosslinking strategy is described in U.S. Pat. No. 6,262,152.

Polymerically dispersed pigments are prepared by mixing the polymeric dispersants and the pigments and subjecting the mixture to dispersing conditions. It is generally desirable to make the stabilized pigment in a concentrated form. The stabilized pigment is first prepared by premixing the selected pigment(s) and polyurethane ionic dispersant(s) in an aqueous carrier medium (such as water and, optionally, a water-miscible solvent), and then dispersing or deflocculating the pigment. The dispersing step may be accomplished in a 2-roll mill, media mill, a horizontal mini mill, a ball mill, an attritor, or by passing the mixture through a plurality of nozzles within a liquid jet interaction chamber at a liquid pressure of at least 5,000 psi to produce a uniform dispersion of the pigment particles in the aqueous carrier medium (microfluidizer). Alternatively, the concentrates may be prepared by dry milling the polymeric dispersant and the pigment under pressure. The media for the media mill is chosen from commonly available media, including zirconia, YTZ and nylon. Preferred are 2-roll mill, media mill, and by passing the mixture through a plurality of nozzles within a liquid jet interaction chamber at a liquid pressure of at least 5,000 psi.

After the milling process is complete the pigment concentrate may be “let down” into an aqueous system. “Let down” refers to the dilution of the concentrate with mixing or dispersing, the intensity of the mixing/dispersing normally being determined by trial and error using routine methodology, and often being dependent on the combination of the polymeric dispersant, solvent and pigment.

A wide variety of organic and inorganic pigments, alone or in combination, may be selected to make the ink. The term “pigment” as used herein means an insoluble colorant which includes disperse dyes as they are insoluble in the inkjet ink. The pigment particles are sufficiently small to permit free flow of the ink through the inkjet printing device, especially at the ejecting nozzles that usually have a diameter ranging from about 10 micron to about 50 micron. The particle size also has an influence on the pigment dispersion stability, which is critical throughout the life of the ink. Brownian motion of minute particles will help prevent the particles from flocculation. It is also desirable to use small particles for maximum color strength and gloss. The range of useful particle size is typically about 0.005 micron to about 15 micron. Preferably, the pigment particle size should range from about 0.005 to about 5 micron and, most preferably, from about 0.005 to about 1 micron. The average particle size as measured by dynamic light scattering is preferably less than about 500 nm, more preferably less than about 300 nm.

The selected pigment(s) may be used in dry or wet form. For example, pigments are usually manufactured in aqueous media and the resulting pigment is obtained as water-wet presscake. In presscake form, the pigment is not agglomerated to the extent that it is in dry form. Thus, pigments in water-wet presscake form do not require as much deflocculation in the process of preparing the inks as pigments in dry form.

### Polyurethane Dispersant

The polyurethane dispersant is derived from a trisubstituted asymmetric branching compound which has three isocyanate reactive substituents where there is a first isocyanate reactive substituent which is a primary or a secondary amine, and the second and third isocyanate reactive substituents are the same or different and are selected from the group consisting of a primary or secondary amine, —OH, —PH and —SH and where at least one of the second and third isocyanate reactive substituents are —OH or —SH; a first diol; a second diol substituted with an ionic group; and isocyanates

This branching will result in at least a portion of the polyurethane being non-linear. The amount of trisubstituted branching compound is from 0.4 to 30 mole percent based on all of the isocyanate reactive groups. At the lower end of this range there will be some of the polyurethanes in the polyurethane which are not branched, but are primarily linear. It is surprising that so little asymmetric branching has such a significant effect on the performance of the polyurethane as a pigment dispersant.

The polyurethane which comprises a trisubstituted asymmetric branching compound which has three isocyanate reactive groups where one or two of them are amines, is a polyurethane pigment dispersant.

The polyurethane dispersant is in either the form of a water soluble polyurethane or an aqueous polyurethane dispersion. The term “polyurethane dispersion” refers to aqueous dispersions of polymers containing urethane groups and optionally urea groups, as that term is understood by those of ordinary skill in the art. These polyurethane polymers also incorporate hydrophilic functionality to the extent required to maintain a stable dispersion of the polymer in water. The second diol containing the ionic group provides the ionic stabilization for the polyurethane dispersion.

### Trisubstituted Branching Compound

The trisubstituted asymmetric branching compound has three isocyanate-reactive substituents where the first isocyanate-reactive substituent is a primary or a secondary amine, and the second and third isocyanate-reactive substituents are the same or different and are selected from the group consisting of a primary or secondary amine, —OH, —PH and —SH and where at least one of the second and third-isocyanate reactive substituents are —OH or —SH.

In general, a trisubstituted asymmetric branching compound is an aliphatic compound with the three isocyanate substituents. Non-limiting examples of the trisubstituted asymmetric branching compound include diethanolamine, bis-(hydroxylmethyl)-methylamine, dipropanolamine, 1,5-diamino-3-(2-hydroxy ethyl) pentane, and 2-aminoethane-(2 hydroxy ethyl) amine.

### First Diols

The asymmetric branched polyurethane ink additive includes first diol components. These isocyanate reactive components are chosen for their stability to hydrolysis and other factors.

Examples of polymeric polyols include polyesters, polyethers, polycarbonates, polyacetals, poly (meth) acrylates, polyester amides, and polythioethers. A combination of these polymers can also be used. For examples, a polyether polyol and a poly (meth)acrylate polyol may be used in the same polyurethane synthesis. In the case of using a polyether polyol, both ionic and nonionic stabilization (from the polyether polyol) can contribute to the stabilization of the polyurethane pigment dispersion.

The polycarboxylic acids may be aliphatic, cycloaliphatic, aromatic and/or heterocyclic or mixtures thereof and they may be substituted, for example, by halogen atoms, and/or unsaturated.

Suitable first diols contain at least two hydroxyl groups, and have a molecular weight of from about 60 to about 6000. Of these, the polymeric first diols are best defined by the number average molecular weight, and can range from about 200 to about 6000, specifically, from about 400 to about 3000, and more specifically from about 600 to about 2500. The molecular weights can be determined by hydroxyl group analysis (OH number). An optional first diol includes those that are derived from monomeric 1,n-diols where n is at least 3 and can be up to about 36.

When the first diol is a polyether diol, the polyether diol may be derived from ethylene oxide, propylene oxide and higher oxetanes. The polyether diol has the formula HO [—(CHR)ₐ—O—]_{b}—H where R is hydrogen or alkyl with 1 to 12 carbons; a and b are integers; a is greater than or equal to 2 to 18; and b is greater than or equal to 2 to about 150. Suitable polyether diols have b equal to 3 or 4. Commercially available compounds for when a=3 and b is greater than 3 include Ceranol™ polyether polyols from DuPont, Wilmington Del. Commercially available compounds for when a=4 and b is greater than 3 include TERATHANE polytetramethylene ether glycols (PTMEG) available from Invista, Wichita, Kans.

Second Diol Substituted with an Ionic Group

The diol substituted with an ionic group contains ionic and/or ionizable groups. Preferably, these reactants will contain one or two, more preferably two, isocyanate reactive groups, as well as at least one ionic or ionizable group.

Examples of ionic dispersing groups include carboxylate groups (—COOM), phosphate groups (—OPO₃ M₂), phosphonate groups (—PO₃ M₂), sulfonate groups (—SO₃ M), quaternary ammonium groups (—NR₃ Y, wherein Y is a monovalent anion such as chlorine or hydroxyl), or any other effective ionic group. M is a cation such as a monovalent metal ion (e.g., Na⁺, K⁺, Li⁺, etc.), H⁺, NR₄⁺, and each R is independently an alkyl, aralkyl, aryl, or hydrogen. These ionic dispersing groups are typically located pendant from the polyurethane backbone.

The ionizable groups in general correspond to the ionic groups, except they are in the acid (such as carboxyl —COOH) or base (such as primary, secondary or tertiary amine —NH₂, —NRH, or —NR₂) form. The ionizable groups are such that they are readily converted to their ionic form during the dispersion/polymer preparation process as discussed below.

The ionic or potentially ionic groups are chemically incorporated into the polyurethanes derived from asymmetric trisubstituted compounds in an amount to provide an ionic group content (with neutralization as needed) sufficient to render the polyurethane dispersible in the aqueous medium of the dispersion. Typical ionic group content will range from about 0.15 up to about 1.8 milliequivalents (meq), optionally, from about 0.36 to about 1.07 meq per 1 g of polyurethane solids.

With respect to compounds which contain isocyanate reactive groups and ionic or potentially ionic groups, the isocyanate reactive groups are typically amino and hydroxyl groups. The potentially ionic groups or their corresponding ionic groups may be cationic or anionic, although the anionic groups are most often used. Examples of anionic groups include carboxylate and sulfonate groups. Examples of cationic groups include quaternary ammonium groups and sulfonium groups.

In the case of anionic group substitution, the groups can be carboxylic acid groups, carboxylate groups, sulphonic acid groups, sulphonate groups, phosphoric acid groups and phosphonate groups. The acid salts are formed by neutralizing the corresponding acid groups either prior to, during or after formation of the NCO pre-polymer preferably after formation of the NCO pre-polymer.

Preferred carboxylic group-containing compounds are the hydroxy-carboxylic acids corresponding to the structure (HO)ⱼQ(COOH)ₖ wherein Q represents a straight or branched, hydrocarbon radical containing 1 to 12 carbon atoms, j is 1 or 2, preferably 2 and k is 1 to 3, preferably 1 or 2 and more preferably 1.

Examples of these hydroxy-carboxylic acids include citric acid, tartaric acid and hydroxypivalic acid. Especially preferred acids are those of the above-mentioned structure wherein j=2 and k=1. These dihydroxy alkanoic acids are described in U.S. Pat. No. 3,412,054, Especially preferred dihydroxy alkanoic acids are the alpha, alpha-dimethylol alkanoic acids represented by the structural formula:

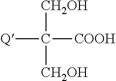

wherein Q′ is hydrogen or an alkyl group containing 1 to 8 carbon atoms. The most commonly used diol compound is alpha, alpha-dimethylol propionic acid, i.e., wherein Q′ is methyl in the above formula.

In order to have a stable dispersion of the polyurethane derived from asymmetric trisubstituted compounds, a sufficient amount of the ionic groups must be neutralized so that the resulting polyurethane will remain stably dispersed in the aqueous medium. Generally, at least about 75%, optionally at least about 90%, of the ionic groups are neutralized to the corresponding salt groups.

Suitable neutralizing agents for converting the acid groups to salt groups before, during, or after their incorporation into the NCO pre-polymers, include tertiary amines, alkali metal cations and ammonia. Preferred trialkyl substituted tertiary amines, such as triethyl amine, tripropyl amine, dimethylcyclohexyl amine, and dimethylethyl amine.

Neutralization may take place at any point in the polyurethane synthesis. A typical procedure includes at least some neutralization of the pre-polymer.

When the ionic stabilizing groups are acids, the acid groups are incorporated in an amount sufficient to provide an acid group content for the urea-terminated polyurethane, known by those skilled in the art as acid number (mg KOH per gram solid polymer), at least about 8 milligrams KOH per 1.0 gram of polyurethane and optionally 20 milligrams KOH per 1.0 gram of polyurethane. The upper limit for the acid number is about 100 and optionally about 60.

The dispersant derived from asymmetric trisubstituted branched compounds has a number average molecular weight of about 2000 to about 30,000 daltons. Optionally, the number average molecular weight is about 3000 to 20000.

The polyurethane dispersant can be a stable aqueous dispersion of polyurethane particles having a solids content of up to about 60% by weight, specifically, about 15 to about 60% by weight and most specifically, about 20 to about 45% by weight. However, it is always possible to dilute the dispersions to any minimum solids content desired. When the polyurethane dispersant is used as a dispersant, the process of dispersing the pigment with the polyurethane results in a stable pigment dispersion with the polyurethane acting as a dispersant.

### Isocyanate Component

Suitable polyisocyanates are those that contain either aromatic, cycloaliphatic or aliphatic groups bound to the isocyanate groups. Mixtures of these compounds may also be used. Preferred are compounds with isocyanates bound to a cycloaliphatic or aliphatic moieties. If aromatic isocyanates are used, cycloaliphatic or aliphatic isocyanates are preferably present as well.

Diisocyanates are preferred, and any diisocyanate useful in preparing polyurethanes and/or polyurethane-ureas from polyether glycols, diisocyanates and diols or diamine can be used.

Examples of suitable diisocyanates include, but are not limited to, 2,4-toluene diisocyanate (TDI); 2,6-toluene diisocyanate; trimethyl hexamethylene diisocyanate (TMDI); 4,4′-diphenylmethane diisocyanate (MDI); 4,4′-dicyclohexylmethane diisocyanate (H₁₂MDI); 3,3′-dimethyl-4,4′-biphenyl diisocyanate (TODD; Dodecane diisocyanate (C₁₂DI); m-tetramethylene xylylene diisocyanate (TMXDI); 1,4-benzene diisocyanate; trans-cyclohexane-1,4-diisocyanate; 1,5-naphthalene diisocyanate (NDI); 1,6-hexamethylene diisocyanate (HDI); 4,6-xylyene diisocyanate; isophorone diisocyanate (IPDI); and combinations thereof. IPDI and TMXDI are most suitable.

### Preparation of the Branched Polyurethane Polymeric Dispersant

The preparation of the polyurethane dispersant derived from a trisubstituted branching compound comprises the steps:

(a) providing reactants comprising (i) at least one trisubstituted branching compound component, (ii) at least one polyisocyanate component, and (iii) at least one first diol and (iv) a second diol containing an ionic group,

(b) reacting (i), (ii), (iii) and (iv) in the presence of a water-miscible organic solvent to form an isocyanate-functional polyurethane pre-polymer;

(c) adding water to form an aqueous dispersion; and

(d) prior to, concurrently with or subsequent to step (c), chain-terminating the isocyanate-functional prepolymer.

For step (a) the reactants may be added in any convenient order.

The second diol contains ionizable groups and at the time of addition of water (step (c)), the ionizable groups may be ionized by adding acid or base (depending on the type of ionizable group) in an amount such that the polyurethane can be soluble or stably dispersed. This neutralization can occur at any convenient time during the preparation of the polyurethane.

At some point during the reaction (generally after addition of water and after chain termination), the organic solvent is substantially removed under vacuum to produce an essentially solvent-free dispersion. Alternatively, suitable, non-volatile solvents may be used and left in the polyurethane dispersion.

It should be understood that the process used to prepare the polyurethane generally results in a polyurethane polymer of the above structure being present in the final product. However, the final product will typically be a mixture of products, of which a portion is the above polyurethane polymer, the other portion being a normal distribution of other polymer products and may contain varying ratios of unreacted monomers. The heterogeneity of the resultant polymer will depend on the reactants selected as well as reactant conditions chosen.

### Ratios of Polyurethane Components

For polyurethane dispersant described above the ratio of isocyanate to isocyanate reactive groups is from about 1.3:1 to about 1.0:1, and suitably from about 1.25:1 to about 1.05:1. In the case where the isocyanate groups are more than the isocyanate reactive groups, often a chain termination group is used. This chain termination groups can include alcohols and amines.

The amount of chain terminator employed should be approximately equivalent to the unreacted isocyanate groups in the prepolymer. The ratio of active hydrogens from amine groups in the chain terminator to isocyanate groups in the prepolymer are in the range from about 1.0:1 to about 1.2:1, suitably from about 1.0:1.1 to about 1.1:1, and suitably from about 1.0:1.05 to about 1.1:1, on an equivalent basis.

In addition to alcohols, aliphatic primary or secondary monoamines are commonly used as the chain termination agents. Example of monoamines useful as chain terminators include but are not restricted to butylamine, hexylamine, 2-ethylhexyl amine, dodecyl amine, diisopropanol amine, stearyl amine, dibutyl amine, dinonyl amine, bis(2-ethylhexyl) amine, diethylamine, bis(methoxyethyl)amine, N-methylstearyl amine, diethanolamine and N-methyl aniline.

Any primary or secondary monoamines reactive with isocyanates may be used as chain terminators. Aliphatic primary or secondary monoamines are preferred. Example of monoamines useful as chain terminators include but are not restricted to butylamine, hexylamine, 2-ethylhexyl amine, dodecyl amine, diisopropanol amine, stearyl amine, dibutyl amine, dinonyl amine, bis(2-ethylhexyl) amine, diethylamine, bis(methoxyethyl)amine, N-methylstearyl amine and N-methyl aniline. An optional isocyanate reactive chain terminator is bis(methoxyethyl)amine. The bis(methoxyethyl)amine is part of a class of urea terminating reactant where the substituents are non-reactive in the isocyanate chemistry, but have nonionic hydrophilic groups. This nonionic hydrophilic group provides the urea terminated polyether diol polyurethane with more water compatibility.

The urea content in percent of the polyurethane dispersant is determined by dividing the mass of chain terminator by the sum of the other polyurethane components including the chain terminating agent. The urea content will be from about 2 wt % to about 14.5 wt %. The urea content will be preferably from about 2.5 wt % to about 10.5 wt %.

It is important that this urea group be the terminating group and there are no substituents in the chain terminating group that can lead to crosslinking or bridging to another polyurethane.

### Aqueous Vehicle

Selection of a suitable aqueous vehicle mixture depends on requirements of the specific application, such as desired surface tension and viscosity, the selected colorant, drying time of the ink, and the type of substrate onto which the ink will be printed. Representative examples of water-soluble organic solvents which may be utilized are those that are disclosed in U.S. Pat. No. 5,085,698.

If a mixture of water and at least one water-miscible solvent is used, the aqueous vehicle typically will contain about 30% to about 95% water with the balance (i.e., about 70% to about 5%) being the water-soluble solvent. Suitable compositions may contain about 60% to about 95% water, based on the total weight of the aqueous vehicle.

The amount of aqueous vehicle in the ink is typically in the range of about 70% to about 99.8%, suitably about 80% to about 99.8%, based on total weight of the ink.

The aqueous vehicle can be made to be fast penetrating (rapid drying) by including surfactants or penetrating agents such as glycol ethers and 1,2-alkanediols. Suitable surfactants include ethoxylated acetylene diols (e.g. Surfynols® series commercially available from Air Products), ethoxylated primary (e.g. Neodol® series commercially available from Shell) and secondary (e.g. Tergitol® series commercially available from Union Carbide) alcohols, sulfosuccinates (e.g. Aerosol® series commercially available from Cytec), organosilicones (e.g. Silwet® series commercially available from Witco) and fluoro surfactants (e.g. Zonyl® series commercially available from DuPont).

The amount of glycol ether(s) and 1,2-alkanediol(s) added must be properly determined, but is typically in the range of from about 1 to about 15% by weight and more typically about 2 to about 10% by weight, based on the total weight of the ink. Surfactants may be used, typically in the amount of about 0.01 to about 5% and preferably about 0.2 to about 2%, based on the total weight of the ink.

### Proportion of Main Ingredients

The pigment levels employed in the instant inks are those levels which are typically needed to impart the desired color density to the printed image. Typically, pigment levels are in the range of about 0.05 to about 10% by weight of the ink. The amount of polyurethane dispersants required to stabilize the pigment is dependent upon the specific polyurethane ionic dispersants, the pigment and vehicle interaction. The weight ratio of pigment to polyurethane dispersant will typically range from about 0.5 to about 6.

Preparation of the Pigment Dispersion

The polyurethane dispersants are dispersants for pigments. In this case, the polyurethane is either 1) utilized as a dissolved polyurethane in a compatible solvent where the initial polyurethane/particle mixture is prepared and then processed using dispersion equipment to produce the aqueous polyurethane dispersed pigment; or 2) the polyurethane dispersion and the pigment dispersed are mixed in a water miscible solvent system which, in turn is processed using dispersion equipment to produce the aqueous polyurethane dispersed pigment where the polyurethane is the dispersant. While not being bound by theory, it is assumed that the pigment and the polyurethane have the appropriate physical/chemical interactions that are required to prepare a stable dispersion of particles especially pigments. Furthermore, it is possible that some of the polyurethane is not bound to the pigment and exists either as a dispersion of the polyurethane or polyurethane dissolved in the liquid phase of the dispersion.

The water miscible solvent is chosen to assure that during the particle dispersion process the polyurethane can function as a dispersant, that is, the polyurethane becomes the dispersant for the pigment. Candidate water miscible solvents include dipropylene glycol methyl ether, propylene glycol normal propyl ether, ethylene glycol monobutyl ether, diethylene glycol monobutyl ether, isopropyl alcohol, 2-pyrrolidone, triethylene glycol monobutyl ether, tetraglyme, sulfolane, n-methylpyrrolidone, propylene carbonate, methyl ethyl ketone, methyl isobutyl ketone, butyrolactone.

After the polyurethane dispersant dispersion preparation, the amount of water-miscible solvent may be more than some ink jet applications will tolerate. For some of the urea terminated polyurethane dispersions, it thus may be necessary to ultrafilter the final dispersion to reduce the amount of water-miscible solvent. To improve stability and reduce the viscosity of the pigment dispersion, it may be heat treated by heating from about 30° C. to about 100° C., with the preferred temperature being about 70° C. for about 10 to about 24 hours. Longer heating does not affect the performance of the dispersion.

The polyurethane pigment dispersions described herein may be effectively used for ink jet inks. While not being bound by theory, it is believed that the polyurethane ionic dispersions provide improved ink properties by the following means. Stable aqueous dispersions are critical for inkjet inks to assure long-lived ink cartridges having few problems with failed nozzles, etc. It is, however, desirable for the ink to become unstable as it is jetted onto the media so that the pigment in the ink “crashes out” onto the surface of the media (as opposed to being absorbed into the media). With the pigment on the surface of the media, beneficial properties of the ink can be obtained.

The polyurethane dispersants provide novel dispersants that sufficiently stabilize the ink prior to jetting (such as in the cartridge) but, as the ink is jetted onto the paper, the pigment system is destabilized and the pigment remains on the surface of the media. This leads to improved ink properties.

### Other Ink Ingredients

Other ingredients may be formulated into the inkjet ink, to the extent that such other ingredients do not interfere with the stability and jettability of the ink, which may be readily determined by routine experimentation. Such other ingredients are in a general sense well known in the art.

Biocides may be used to inhibit growth of microorganisms.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), diethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

### Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 70 dyne/cm at 25° C. Viscosity can be as high as 30 cP at 25° C., but is typically somewhat lower. The ink has physical properties compatible with a wide range of ejecting conditions, i.e., driving frequency of the piezo element, or ejection conditions for a thermal head, for either a drop-on-demand device or a continuous device, and the shape and size of the nozzle. The inks should have excellent storage stability for long periods so as not to clog to a significant extent in an ink jet apparatus. Further, the ink should not corrode parts of the ink jet printing device it comes in contact with, and it should be essentially odorless and non-toxic.

Although not restricted to any particular viscosity range or printhead, the inventive ink set is particularly suited to lower viscosity applications such as those required by thermal printheads. Thus, the viscosity (at 25° C.) of the inventive inks can be less than about 7 cP, is preferably less than about 5 cP, and most advantageously is less than about 3.5 cP. Thermal inkjet actuators rely on instantaneous heating/bubble formation to eject ink drops and this mechanism of drop formation generally requires inks of lower viscosity.

### Substrate

The instant invention is particularly advantageous for printing on plain paper, such as common electrophotographic copier paper and photo paper, glossy paper and similar papers used in inkjet printers. Textiles can also be used as a substrate.

### EXAMPLES

### Extent of Polyurethane Reaction

The extent of polyurethane reaction was determined by detecting NCO % by dibutylamine titration, a common method in urethane chemistry. In this method, a sample of the NCO containing pre-polymer is reacted with a known amount of dibutylamine solution and the residual amine is back titrated with HCl.

### Particle Size Measurements

The particle size for the polyurethane dispersions, pigments and the inks were determined by dynamic light scattering using a MICROTRAC UPA 150 analyzer from Honeywell/Microtrac (Montgomeryville Pa.).

This technique is based on the relationship between the velocity distribution of the particles and the particle size. Laser generated light is scattered from each particle and is Doppler shifted by the particle Brownian motion. The frequency difference between the shifted light and the unshifted light is amplified, digitalized and analyzed to recover the particle size distribution. Results are reported as D50 and D95.

### Solid Content Measurement

Solid content for the solvent free polyurethane dispersions was measured with a moisture analyzer, model MA50 commercially available from Sartorius. For polyurethane dispersions containing high boiling solvent, such as NMP, tetraethylene glycol dimethyl ether, the solid content was then determined by the weight differences before and after baking in 150° C. oven for 180 minutes.

### Molecular Weight Characterization of the Polyurethane Dispersant

All molecular weights were determined by GPC using poly (methyl methacrylate) standards with tetrahydrofuran as the eluent. Using statics derived by Flory, the molecular weight of the polyurethane may be calculated or predicted based on the NCO/OH ratio and the molecular weight of the monomers. Molecular weight is also a characteristic of the polyurethane that can be used to define the polyurethane. The molecular weight is routinely reported as number average molecular weight, Mn. The polyurethane dispersant is not limited to Gaussian distribution of molecular weight, but may have other distributions such as bimodal distributions.

### Asymmetric Branched Polyurethane Dispersant Example 1

### IPDI/T650/DEA BMEA 45 AN

A 2 liter reactor was loaded with 288.53 g Terathane 650 (OH # 172.3, Invista Chemical), 181.95 g tetraglyme, and 0.96 g diethanolamine. While stirring at room temperature 224.14 g isophorone diisocyanate was added over the course of 60 minutes. Temperature was allowed to rise during addition. 61.91 g dimethylol propionic acid was then added to the reactor followed by a 9.58 g rinse of tetraglyme solvent. The reaction was heated to 80° C. and when the solution was clear 0.04 g of dibutyl tin dilaurate was added. When the % NCO was below 1.5%, 24.50 g bis(2-methoxy ethyl)amine was added over 30 minutes followed by a 9.58 g tetraglyme solvent rinse. The reaction was held at 80° C. for 1 hr. The polyurethane solution was inverted under high speed mixing by adding a mixture of 25.87 g KOH in 1684.0 g water. The polyurethane solution had measured solids of 24.99% and a viscosity of 18.7 cPs (30 rpm).

### Asymmetric Branched Polyurethane Dispersant Example 2 and 3

These dispersants are made in a manner similar to Example 1 except the molar amounts of the reactants are changed. The molar amounts are listed in Table 1.

TABLE 1
Composition of Dispersant Examples 1-3

| | Branching | Mole | Branching | Terathane ® | | | | | | |
|---|---|---|---|---|---|---|---|---|---|---|
| | Monomers, | percent of | Monomers. Amt | 650 | DMPA | IPDI | Tetraglyme | BMEA | KOH1 | Water |
| | type | trisubstitution | moles | moles | moles | moles | grams | moles | moles | grams |
| Inv 1 | DEA | 1.4% | 0.009 | 0.44 | 0.46 | 1.01 | 201 | 0.18 | 0.46 | 1684 |
| Inv 2 | DEA | 7.0% | 0.049 | 0.42 | 0.46 | 1.05 | 339 | 0.19 | 0.46 | 1536 |
| Inv 3 | DEA | 14.8% | 0.066 | 0.23 | 0.28 | 0.67 | 114 | 0.12 | 0.28 | 1011 |

### Example of Dispersed Pigment with Asymmetric Branched Polyurethane Dispersant 1

An example where the branched polyurethane is used as a dispersant demonstrates the capability of preparing stable pigment dispersions with non-linear dispersants which are asymmetrically substituted at the branching point. As noted PU 1 is the asymmetric branched dispersant 1 described above.

A pigment and dispersant pre-mix was prepared using the following formula

| | | |
|---|---|---|
| D.I. water | 218.97 | g |
| PU 1* | 133.12 | g |
| TEB** | 50.00 | g |
| Nipex 180 | 100.00 | g |

*PU1 @ 24.9% resin solids
**Triethylene glycol monobutyl ether

This pre-mix was processed with an high speed disperser @ ˜3000 RPM for 2 hours, then processed through a Microfluidizer at 15,000 psi for 4 hours (12 passes). During the microfluidization the pre-mix is diluted twice with 100 grams D.I. water. At the end of the microfluidization the samples was milled an additional 15 minutes then diluted further with 1300 grams D.I. water. The final pigment dispersion had the following properties.

| | |
|---|---|
| Pigment solids | 5.0% |
| Particle Size (nm) | |
| Microtrac D50 | 123.9 nm |
| Microtrac D95 | 222.2 nm |
| Microtrac % < 204 nm | 91.7 |

### Preparation of Inventive Inks Using the Asymmetric Polyurethane Dispersants

Inks are prepared using the pigments dispersed with branched Polyurethane Ink dispersants.

All ingredients listed below, except the carbon black dispersion, are mixed together. The pigment dispersion are then added slowly, with continuous mixing. The pigment and binder are added to be 3.0% and 2.0%, respectively, in the final ink.

TABLE 2
Ink Compositions

| Ink Ingredient | Weight % in Ink |
|---|---|
| Butyl Cellosolve | 10.0% |
| Butyl Carbitol | 16.0% |
| 2-Pyrrolidone | 5.0% |
| Polyurethane Binder | 2% |
| Sulfolane | 3% |
| Polymer Dispersed Carbon | 3% |
| Black Aqueous Dispersion. | |
| De-ionized Water | Balance to 100% |

The inks made in this fashion are printed on various paper media and other substrates

1. An aqueous pigment dispersion comprising an aqueous vehicle, a pigment and a asymmetric branched polyurethane dispersant, wherein
a. the asymmetric branched polyurethane dispersant physically adsorbs to the pigment;
b. the asymmetric branched polyurethane dispersant stably disperses the pigment in the aqueous vehicle;
c. the asymmetric branched polyurethane dispersant comprises a trisubstituted branching compound, a first diol, a second diol substituted with an ionic group, and isocyanates;
wherein the trisubstituted branching compound has three isocyanate reactive substituents,
wherein the first isocyanate reactive substituent is a primary or secondary amine, and the second and third isocyanate reactive substituents are the same or different and are selected from the group consisting of a primary or secondary amine, —OH, and —SH and where at least one of the second and third isocyanate reactive substituents are —OH or —SH,
wherein the isocyanate reactive substituents of the trisubstituted branching compound is from 0.4 to 30 mole percent of the total isocyanate reactive substituents including the trisubstituted branching compound and,
wherein the average pigment size of the aqueous pigment dispersion is less than about 300 nm.

2. An aqueous colored ink jet ink comprising the aqueous pigment dispersion of claim 2, having from about 0.1 to about 10 wt % pigment based on the total weight of the ink, a weight ratio of the pigment to the asymmetric branched polyurethane dispersant of from about 0.5 to about 6, a surface tension in the range of about 20 dyne/cm to about 70 dyne/cm at 25° C., and a viscosity of lower than about 30 cP at 25° C.

3. The aqueous pigment dispersion of claim 2, wherein the asymmetric branched polyurethane dispersant has an acid number (mg KOH per gram solid polymer) of at least 10 and at most 100.

4. The aqueous pigment dispersion of claim 2, wherein the asymmetric branched polyurethane dispersant has a number average molecular weight of about 2000 to about 30,000 daltons.

5. The aqueous pigment dispersion of claim 2, wherein the aqueous vehicle is a mixture of water and at least one water-miscible solvent.

6. The aqueous pigment dispersion of claim 1, wherein the pigment is a dispersed dye.

7. The asymmetric branched polyurethane dispersant of claim 1, where the first diol is a polyether diol.

8. The polyether diol of claim 7, wherein the polyether diol has the structure;
a. HO [—(CHR)ₐ—O—]_{b}—H
b. wherein R is hydrogen or alkyl having 1 to 12 carbons;
c. a and b are integers, where a is greater than or equal to 2 to 18; and b is greater than or equal to 2 to about 150.

9. The polyether diol of claim 8, where a is 3 or 4.

10. The asymmetric branched polyurethane dispersant of claim 1, where the asymmetric branched polyurethane dispersant is chain terminated with an amine.

11. The asymmetric branched polyurethane dispersant of claim 10, where the amine contains nonionic hydrophilic groups.

12. An inkjet ink set wherein at least one of the inks in the inkjet ink set is the aqueous inkjet ink of claim 2.

13. A method of ink jet printing onto a substrate comprising, in any workable order, the steps of:
a. providing an ink jet printer that is responsive to digital data signals;
b. loading the printer with a substrate to be printed;
c. loading the printer with the aqueous inkjet ink of claim 2;
d. printing onto the substrate using the aqueous ink jet ink, in response to the digital data signals to form a printed image on the substrate.

14. A method of ink jet printing onto a substrate comprising, in any workable order, the steps of:
a. providing an ink jet printer that is responsive to digital data signals;
b. loading the printer with a substrate to be printed;
c. loading the printer with the aqueous inkjet ink set of claim 12;
d. printing onto the substrate using the aqueous inkjet ink set, in response to the digital data signals to form a printed image on the substrate.
